(19) United States
(12) Patent Application Publication
(10) Pub. No.: US 2004/0028769 A1
(43) Pub. Date: Feb. 12, 2004

(54) Foam sandwich composite molding method and apparatus

(76) Inventors: Andrew S. Kreager, Mason, OH (US); Stephen P. Andrzejewski, Middletown, OH (US); Philip T. Dodge, Cincinnati, OH (US); Barry T. Aubrey, Amelia, OH (US)

Correspondence Address: BROOKS KUSHMAN P.C., 1000 TOWN CENTER, TWENTY-SECOND FLOOR, SOUTHFIELD, MI, 48075, US

(21) Appl. No.: 10/426,376

(22) Filed: Apr. 29, 2003

Related U.S. Application Data
(60) Provisional application No. 60/376,648, filed on Apr. 30, 2002.

(51) Int. Cl. B29C 31/04

(52) U.S. Cl. 425/375

(57) ABSTRACT

The present invention provides a tip molding apparatus for forming a three layered plastic part. The apparatus of the invention includes a conveyor for transporting a mold half through the tip molding apparatus; an oven for heating the mold half, wherein the conveyor transports the mold half through the oven; a skin resin loader that introduces a first powdered skin resin into the mold half after the mold half exits the oven; and at least one mold inverter that inverts the male mold half by a sufficient amount to pour out any first powder resin not adhered to the first mold half. Additionally, sections of the tip molding apparatus may further include a foam resin loader that introduces a foam resin into the mold half. A method of forming a three layer plastic part by the method of the invention is also provided.

### CROSS-REFERENCE TO RELATED APPLICATIONS

This application claims the benefit of U.S. provisional application Serial No. 60/376,648 filed Apr. 30, 2002.

### BACKGROUND OF THE INVENTION

1. Field of the Invention

This invention relates to plastic molding resins and methods of forming a reinformed three layer plastic part from such resins. More specifically, the present invention relates to resins capable of being used in a tip molding process and to methods of making parts by such a tip molding process.

2. Background Art

Plastic molding processes are widely used in the automotive industry to produce such diverse plastic parts as truck beds, instrument panels, console boxes, door trims, and interior trim. Although numerous methods exist for molding plastic parts, the even increasing structural demands on such plastic parts necessitates the development of new and improved molding processes. One solution for better performance from plastic parts is a foam sandwich construction which consists of a plastic foam layer disposed between two plastic skin layers (“sandwich construction”). This sandwich construction is capable of replacing steel assemblies and fiberglass lay-ups in boat, RV, and automotive applications. Furthermore, with the appropriate material selection and layer structure the strength to weight ratio is better than fiberglass lay-ups and steel. However, the latter improvement is only true at temperatures below 150° F. At higher temperatures, the sandwich composite softens causing creep (deflection under load over long period of time) to become a problem even at low stress levels. In addition, CLTE (coefficient of linear thermal expansion) is higher for a sandwich composite than either steel or fiberglass. This difference in CLTE creates fit and finish problems when a simple polyolefin based sandwich construction is used.

One solution to the problems associated with the sandwich construction is to incorporate reinforcements such as welded wire mesh, fiberglass mats, and other structural components. It is known that such reinforcements improve both high temperature creep and CLTE. Furthermore, ribbed kiss-offs and conical kiss-offs are known to improve stability and increase the useful temperature range of sandwich constructions. Several plastics molding techniques are capable of forming reinforced sandwich constructions.

Powder tip molding (“tip molding”) is an emerging plastic molding technology which is capable of meeting many of these structural requirements through the production of reinforced plastic parts. In the tip molding process, open face mold halves are filled with powder and heated to form a plastic skin layer. Reinforcements are added along with a preformed foam middle layer. The mold halves are then clamped together and then heated to form a three layer foam sandwich composite. The use of a preformed middle layer presents a number of technical difficulties. For example, the use of preformed layers makes it difficult to completely fill corners and to fabricate parts with thin cross-sections. The advantage of an improved tip molding process as disclosed in the present invention is readily apparent by examining the more common molding technologies.

Rotational molding (“roto-molding”) is perhaps the closest technology to tip molding. Roto-molding has been a commercial process for years. In roto-molding a polymer powder is placed in an enclosed mold and heated until the plastic is molten. The mold is then rotated such that all the mold surfaces are coated with plastic. The rotation of the mold allows the fabrication of a hollow part with uniform wall thickness. Roto-molding has successfully produced parts as large as 11 feet by 7 feet with a weight of at least 250 lbs. Parts much larger than this are difficult to make by roto-molding because of the prerequisite large mold thickness that would be necessary to ensure dimensional stability. Furthermore, roto molding is capable of producing hollow part with a sandwiched construction. In such a sandwich construction, a plastic foam layer is interposed between two plastic skin layers. However, roto-molding is limited by the types of reinforcements which can be incorporated into a plastic part. Reinforcements must be blended with the plastic powder before it is dropped into the mold. Accordingly, it is not possible to incorporate such structures as fiberglass matts. Furthermore, it is difficult to mold very thin parts by roto-molding (less than 1.5 inches).

Injection molding is capable of producing parts with a reinforced foam sandwich construction. In injection molding plastic resin is heated to the point where it will flow under pressure. The plastic is then injected into a mold. A three layer sandwich part can be made by forming the two skin layers by injection mold and then subsequently welding the skins together. The resultant hollow core is then filled with a foam to form the three layer sandwich part. Although injection molding may produce an excellent three layered part, the high cost of equipment and tooling precludes production of such parts except in special cases.

Alternatively, three layer structures may be made by twin sheet forming in which two plastic sheets are forced against each other by either a vacuum or pressure to form a double-walled part with a central cavity. The middle foam layer is added as a secondary step. Reinforcements such as wire mesh, fiberglass mat and structural inserts are easily incorporated . The sheet stock can be made with a percentage of long glass fibers eliminating the need for other reinforcements. A drawback of twin sheet forming is that the process is slow and requires large amounts of space and extra labor. Furthermore, large parts are not easily made by twin sheet forming. Finally, some sections of parts made by twin sheet forming are made thicker because it is not possible to get a truly uniform sidewall distribution of the skin layers. Accordingly, parts heavier than those with perfectly uniform skin thicknesses.

Three layer structures made by compression molding are made from skins in the form of molten “blobs” which are bonded to reinforcements and a preformed core (not foam) via heat and pressure. The process is limited because foam cores tend to collapse before bonding pressure is achieved. Shapes are typically limited to very simple flat sections unless more complicated multi-piece assemblies are used.

Blow-molding is another technology that is used to form hollow plastic parts. In the typical blow-molding process, plastic is introduced between two mold halves and forced outward by pressurized air to form a part having the shape of the mold. Co-extrusion equipment is readily available for blow-molding operation that will allow the converter to make flat panels with kiss-offs and a long glass fiber reinforced layer. Structural reinforcements are readily incorporated into parts with blow-molding and the parts can be foamed in a secondary step. Furthermore, parts made by blow-molding have reasonable stiffness and dimensional stability. However, there are significant limitations to the blow-molding process. The equipment and tooling required is very expensive necessitating an initial capital investment that can only be justified for very high volume jobs that are slated to run for many years. Furthermore, the lead-time for equipment is substantial and the process is limited to relatively small parts. Specifically, parts that weigh less than 100 lbs. and that are not more than 3 feet×6 feet long. Finally, the top and bottom skins of sandwich type parts must necessarily have the same structure.

For the reasons set forth above, there exists a need for an improved molding process for forming reinforced three layered plastic parts that are relatively inexpensive and capable of forming large parts.

### SUMMARY OF THE INVENTION

The present invention overcomes the problems encountered in the prior art by providing an improved apparatus for forming a plastic part by the tip molding process. The apparatus of the invention is particularly useful for forming a three layered plastic part comprising a plastic foam layer sandwiched between two plastic skin layers. The apparatus of the invention includes a conveyor for transporting a mold half through the tip molding apparatus; an oven for heating the mold half, wherein the conveyor transports the mold half through the oven; a skin resin loader that introduces a first powdered skin resin into the mold half after the mold half exits the oven; and at least one mold inverter that inverts the male mold half by a sufficient amount to pour out any first powder resin not adhered to the first mold half. Additionally, sections of the tip molding apparatus may further include a foam resin loader that introduces a foam resin into the mold half.

In another embodiment of the present invention, a method of forming a three layer plastic part is provided. This method advantageously utilizes the apparatus of the invention. Specifically, the method of the invention comprises transporting a first mold half through an oven for heating the first mold half. After the first mold half has been heated to a sufficiently high temperature the mold half exits the oven and a powdered skin resin is introduced. The plastic skin resin melts and forms a plastic skin layer covering a portion of first mold half. Next, the first male mold half is inverted by a sufficient amount to pour out any powdered skin resin not adhered to the first mold half. The method of further comprising introducing a foam resin into the first mold half. Subsequently, the first mold half is mated with a second mold half. This second mold half is also coated with a skin resin formed by the same method by which the first mold half was coated. The foam resin is then activated to form a foam layer. Typically this activation is with heat. Finally, the joined halves are separated and a three layered plastic part removed.

### BRIEF DESCRIPTION OF THE DRAWINGS

The invention will now be described in greater detail in the following way of example only and with reference to the attached drawings, in which:

FIG. 1 is a cross-section through a three layer plastic part with wire reinforcements made with the resins of the present invention;

FIG. 2 is a cross-section through a three layer plastic part with wire, tubular, and fiber matting reinforcements made with the resins of the present invention;

FIG. 3a is a top view of the upper section of the tip molding apparatus of the present invention;

FIG. 3b is a top view of the lower section of the tip molding apparatus of the present invention;

FIG. 4 is a side view of the tip molding apparatus of the present invention;

FIG. 5a is a schematic cross-section illustrating the mating of a male mold half with an insulation box and a charging shield;

FIG. 5b is a schematic cross-section illustrating the mating of a female mold half with an insulation box and a charging shield;

FIG. 6 is a schematic of a variation of the molding apparatus of the present invention in which additional molding stations are adjacently placed so that the same robots may be used for each station;

FIG. 7 is a schematic illustrating the movement of the hoppers used in the tip molding apparatus of the present invention;

FIG. 8a is a schematic of a venting plug used in the method and apparatus of the present invention with the venting plug exposed;

FIG. 8b is a schematic illustrating the formation of parting lines in the method of the present invention;

FIG. 8c is a schematic illustrating the formation of a kiss-off in the method of the present invention; and

FIG. 9 is a top view illustrating the mounting of a mold half on a conveyor belt as used in the tip molding apparatus of the present invention.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

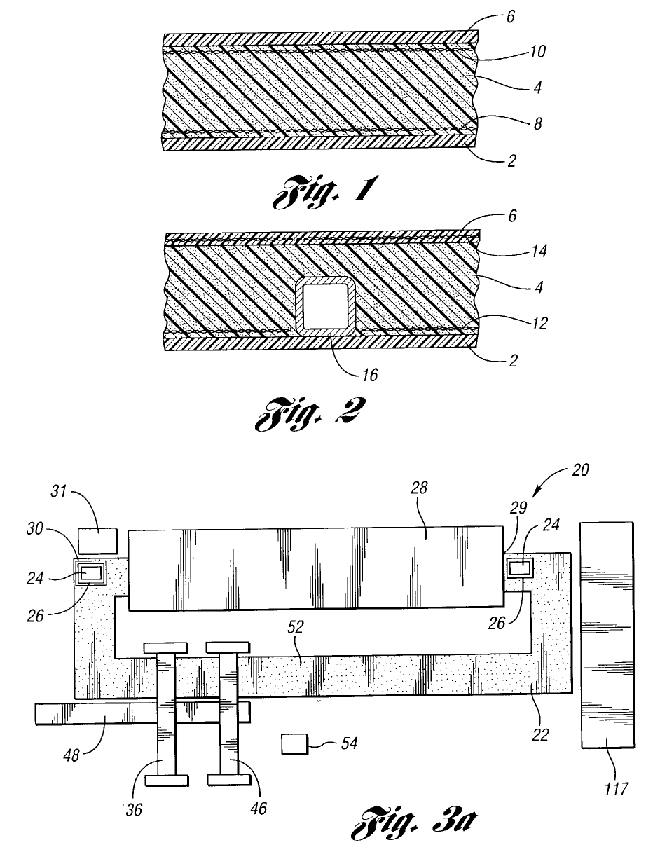

The present invention provides an apparatus and method for forming a plastic molded part by the tip molding process. With reference to FIG. 1, a cross-section of a plastic part made by the method and apparatus of the present invention is provided. First skin layer 2 is disposed over middle foam layer 4. Preferably, the middle foam layer will completely cover first skin layer 2. However, if desired, regions of first skin layer 2 may be uncoated by middle foam layer 4. Similarly, second skin layer 6 is disposed over middle foam layer 4. Skin layer 6 need not be the same plastic skin resin as skin layer 2. Wire screen 8 is embedded in middle foam layer 4 near the interface to skin layer 2 and wire screen 10 is embedded in foam layer 4 near the interface to skin layer 6. Skin layers 2, 6 are made by the tip molding process utilizing the skin resin of the present invention, while middle foam layer 4 is made by the tip molding process utilizing the foam resin of the present invention.

With reference to FIG. 2, a cross-section of a portion of a reinforced plastic part made by the method and process of the present invention is provided. First skin layer 2 is disposed over middle foam layer 4. Similarly, second skin layer 6 is disposed over middle foam layer 4. Fiber matting 12 is embedded in middle foam layer 4 near the interface to skin layer 2 and wire screen 14 is embedded in skin layer 6. Tubular reinforcement 16 is embedded in foam layer 4 near the interface with skin layer 2.

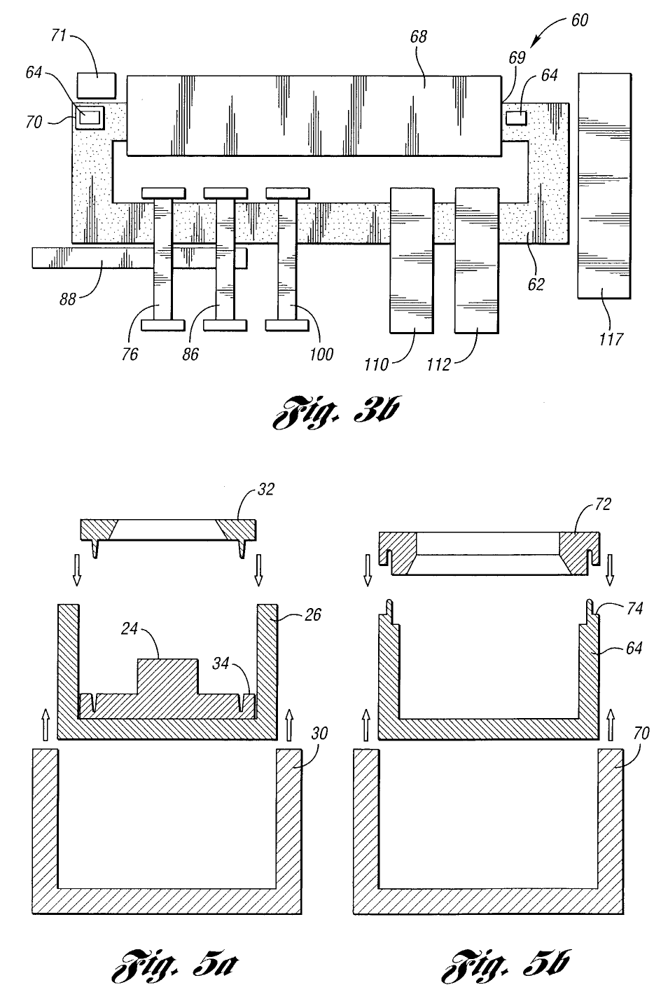

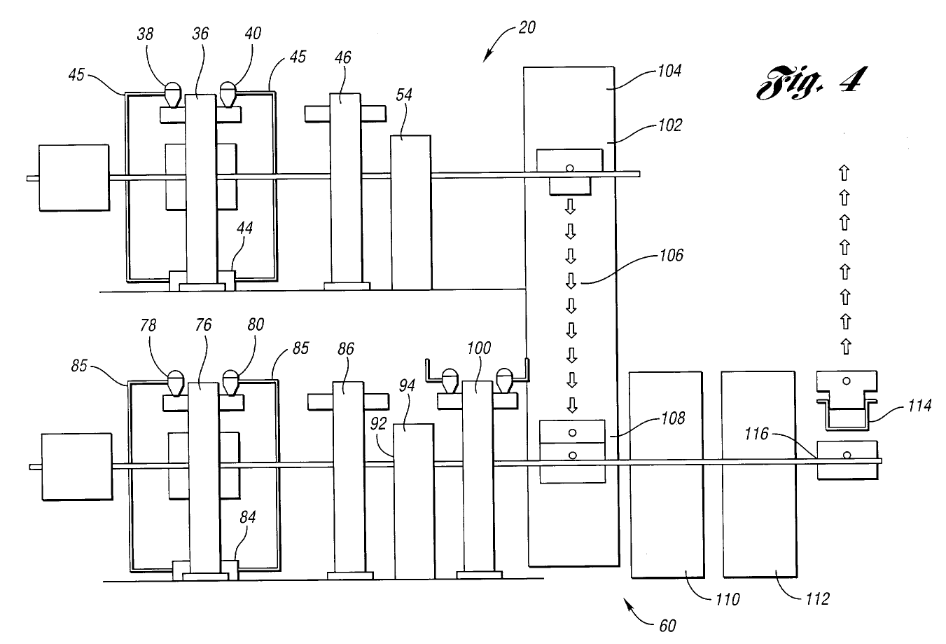

With reference to FIGS. 3a, 3b, 4, 5a, and 5b, a schematic of the apparatus of the present invention is provided. FIG. 3a provides a top view of the upper section of the tip molding apparatus of the present invention while FIG. 3b provides a top view of the lower section of the tip molding apparatus of the present invention. FIG. 4 provides a side view of a portion of the tip molding apparatus demonstrating the placement of the upper section over the lower section. FIG. 5a provides a schematic cross-section illustrating the mating of a male mold half with an insulation box and a charging shield while FIG. 5b provides the mating of a female mold half with an insulation box and charging shield. The tip molding apparatus of the present invention includes upper section 20. Upper section 20 includes conveyors 22 upon which a first mold half 24 is placed. First mold half 24 is preferably a male mold half. In such cases, a male mold half must be placed in carrier 26 before being placed on conveyor 22. Internal structural inserts or stand offs for mounting external structural inserts are attached or mounted to the mold either by an operator or a robot (not shown.) The term “robot” as used herein refers to any automated machine. Male mold half 24 enters multi-chamber oven 28 at position 29. As male mold 24 travels within oven 28 it is heated with hot air for about ten minutes until attaining a desired target temperature. Hot air provides the most uniform temperature. The target temperature will depend on the part type and plastic used. For a typical part made from HDPE, the temperature of the molding surface is about 450° F. After first mold half 24 exits oven 28, it is mated with insulation box 30 by robot 31 (or any similar mechanical devise on the conveyor) so that heat is retained and additional heating is not required. Charging shield 32 is placed over any portion of parting line 34 to which material is not supposed to stick.

Mold half 24 indexes to robot 36 (or any similar mechanical device on the conveyor) at which point a powdered skin layered resin is quickly delivered through slotted hoppers 38, 40 that move from one end of the first mold half 24 to the other. The movement of the hoppers is described in more detail below. Preferably, robot 36 is a two axis robot onto which slotted hoppers 38, 40 are mounted. Optionally, male mold half is vibrated along two axes in a plane parallel to the mold plane until the corners of the first mold half 24 is filled and there are no voids underneath any inserts. The vibration also assists in venting air trapped between the surface of the mold and the powder when the powder is delivered to the mold. Elimination of the trapped air results in a smoother, higher quality surface finish and eliminates the formation of voids in the skin layer. The powder is allowed to dwell and melts onto the mold surface until desired skin thickness is obtained. Typically 1 mm skin thickness is deposited for each minute of dwell time. First mold half 24 is then inverted by robot 36 or other suitable mechanical device and vibrated which causes unmelted plastic to fall from the mold. Optionally, air can be gently blown on the mold surface to remove unmelted powder. The plastic falls into slotted bins 44. A vacuum is drawn through the slot bin 44 so that dust is minimized. The material is conveyed back to the hopper by vacuum systems 45. For material blends such as powder and long glass fibers, a separation step is performed before the materials are recycled to a blender system (not shown). The two separated components are then feed back into the blender system as neat materials.

First mold half 24 indexes to robot 46 (or any similar mechanical device on the conveyor) where reinforcements are placed. The reinforcements are provided to robot 46 by conveyor 48. If reinforcements need to be buried, the first mold half 24 is indexed back under robots 36 where additional powder is added, vibrated, and removed as described above. Optionally, if additional heat is needed, mold half 24 is indexed to robots 36 by passing through oven 28. Insulation box 30 and charging shields 32 are de-coupled at positions 52 by robot 54 (or any similar mechanical device on the conveyor) and recycled for use with the next mold.

Still referring to FIGS. 3a, 3b, 4, and 5b the apparatus of the present invention also includes lower section 60. Lower section 60 includes conveyors 62 upon which second mold half 64 is placed. Preferably, second mold half is a female mold half. Internal structural inserts or stand offs for mounting external structural inserts are attached or mounted to the mold either by an operator or a robot (not shown). Second mold half 64 enters multi-chamber oven 68 at position 69. As second mold 64 moves down conveyers 62, first mold half 64 is heated with hot air as set forth above for the first mold half. After first mold half 64 exits oven 68, it is mated with insulation box 70 by robot 71 (or any similar mechanical device on the conveyor) so that heat is retained and additional heating is not required. Charging shield 72 is placed over any portion of parting line 74 that material is not supposed to stick.

Second mold half 64 indexes to robot 76 (or any similar mechanical device on the conveyor) at which point powdered skin layer resin is quickly delivered through slotted hoppers 78, 80 that move from one end of the first mold half 64 to the other. Preferably, robot 76 are two axis robots onto which slotted hoppers 78, 80 are mounted. Optionally, second mold half 64 is vibrated along two axis in a plane parallel to the mold plane until the corners of the second mold half 64 is filled and there are no voids underneath any inserts. Second mold half 64 is then inverted by robot 82 (or any similar mechanical device on the conveyor) and vibrated which causes unmelted plastic to fall from the mold. Optionally, air can be gently blown on the mold surface to remove unmelted powder. The plastic falls into slotted bins 84. A vacuum is drawn through the slots of bin 84 so that dust is minimized. The material is conveyed back to the hopper by vacuum systems 85. For material blends such as powder and long glass fibers, a separation step is performed before the materials are recycled to a blender system (not shown). The two separated components are then feed back into the blender system as neat materials.

The mold halves used in the present invention are preferably of relatively thin metal sheets in order to allow for good heat transfer so that cycle times are minimized. However, the mold halves must be made from sufficiently thick material to provide for dimensional stability and repeatability. Suitable thicknesses are from about 0.375 inches to about 0.625 inches with a honeycomb-like backup structure. Such ribs as in the honeycomb structure provide the necessary strength and added surface area for heat transfer.

Still referring to FIGS. 3a, 3b, and 4, second mold half 64 indexes to robot 86 (or any similar mechanical device on the conveyor) where reinforcements are placed. The reinforcements are provided to robot 86 by conveyor 88. Reinforcements are placed in mold half 64 by robot 86. If reinforcements need to be buried, the second mold half 64 is indexed back under robots 76 where additional powder is added, vibrated, and removed as described above. Optionally, if additional heat is needed, mold half 64 is indexed to robots 76 by passing through oven 68. Insulation box 70 and charging shields 72 are de-coupled at positions 92 by robot 94 (or any similar mechanical device on the conveyor) and recycled for use with the next mold. Mold half 64 is indexed to robot 100 (or any similar mechanical device on the conveyor) and charged with foam forming resin. The preferred foam forming resin is set forth below. Furthermore, first mold half 24 is inverted at position 102 and prepared for mating by robot 104 (or another similar mechanical device on the conveyor). Special attention must be provided for aesthetic parts to prevent show through of the foam at the kiss-offs. Even if the foam is colored, after it expands it can result in a small lighter colored patch at the kiss off surfaces. Accordingly, kiss-offs are placed facing up in the lower track mold and foam material is delivered in such a way that it does not cover the kiss-off face.

First mold half 24 is moved along direction 106 and mated with second mold half 64 at position 108 by robot 104 (or another similar mechanical device on the conveyor) with sufficient force to form a compression mold at the parting line and kiss-offs. Typical pressures needed to mate the mold halves are from about 5 to about 50 psi. Accordingly, the present invention provides for low pressure molding. For example, in a 20 inch wide by 50 inch long mold there are about 20 square inches of kiss-offs and parting lines. With these parameters, the mold has to be closed with about 1000 lbs of force—that equals only one psi over the whole mold. The mated mold halves enter hot air oven 110 where heat is applied until the foam resin is activated. This typically takes about 5 minutes. Male mold half 24 and second mold half 64 enter cooling station 112 where a water mist stream is sprayed over the mold surfaces for about 10 minutes. In some cases it may be necessary to vary the spray temperature and rate applied to the bottom verses the top in order to obtain a flat part. In a variation of this embodiment, mold halves 24, 64 can be immersed directly into a cold water bath. Plastic part 114 is demolded at position 116 where secondary operations are performed on the part as required along transport conveyor 117. These operations are done to the mold in preparation for the next molding cycle after the part has been demolded. Such secondary operations include trimming, flash drilling holes, and the like. These secondary operations are either performed manually by an operator or by utilizing automated equipment such as additional robots. The typical part resulting from this process is described by FIGS. 1 and 2 as set forth above. Typically, the total cycle time for fabricating a part by the method of the present invention is from about 30 minutes to about one hour per mold depending on part construction. More preferably, the total cycle time is about 35 minutes to about 40 minutes. Preferably, the apparatus of the present invention will allow five molds to be run on each of two recirculating tracks. The result is a part every four minutes. Through put is further increased by running multiple cavities per mold.

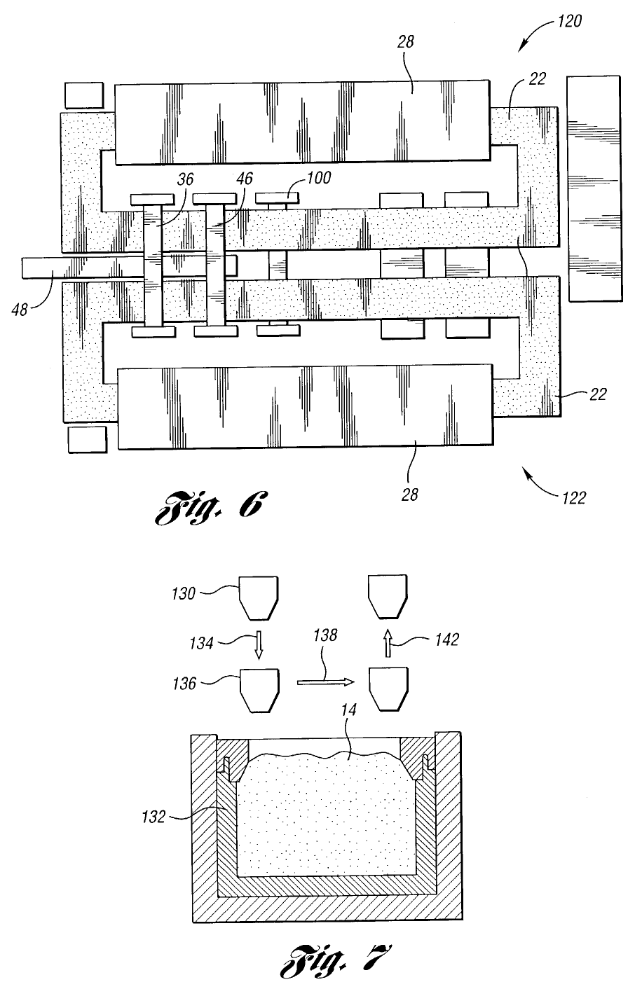

With reference to FIG. 6, a schematic of a variation of the present invention in which additional molding stations are adjacently placed so that the same robots may be used for each station is provided. This variation includes mold sections 120, 122. Both mold sections 120, 122 have an upper and lower mold section as described above. Furthermore, this variation allows for robots 36, 46, 76, 100 to be used simultaneously by both mold sections 120, 122.

With reference to FIG. 7, a schematic illustrating the movement of the hoppers is provided. Hopper 130 moves down towards mold half 132 along direction 134 to position 136. Hopper 130 is then traversed across mold half 132 along direction 138 during which resin is dropped into mold half 132 until mold half 132 is filled to level 140. Hopper 132 is then raised up along direction 142 when the mold half has been sufficiently filled.

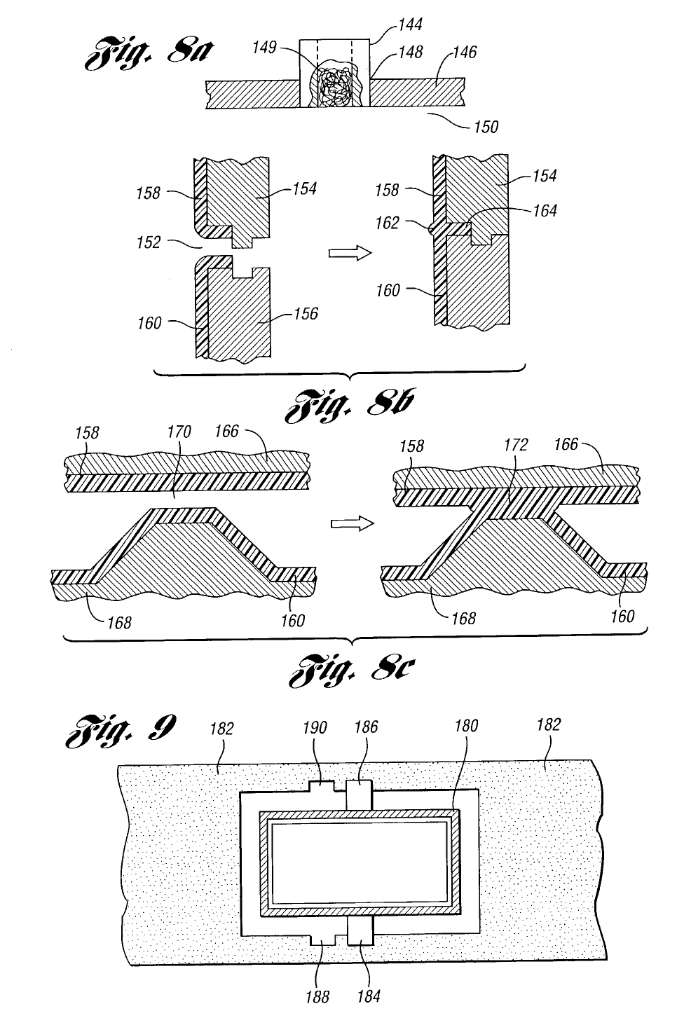

With reference to FIGS. 8a-c additional features of the molds used the method of the present invention are provided. The molds will typically include several plugs for venting gas from the mold halves. FIG. 8a provides a diagram of plug 144. Plug 144 protrudes out of mold section 146 at position 148. Moreover, plug 144 will optionally be filled with material 149 that allows for gas to escape from mold interior 150 while not allowing molten plastic to escape. Plug 144 will often be cylindrical with an inner diameter of about 0.5 inches. FIG. 8b provides a schematic of a parting line formed by the joining of two mold halves in the method of the present invention. At position 152, upper mold section 154 is not in contact with lower mold section 156. When the mold halves are brought together, skin layer 158 contacts skin layer 160 to form parting line 162. In making contact upper gap 164 is formed to allow the parting line to form. Typically, gap 164 will be from about 0.5 to about 1.5 times the sum of the thickness of skin layer 158 and skin layer 160. FIG. 152c provides a schematic of a kiss-off that may be formed by the method of the present invention. The kiss-offs formed in a part may be ribbed and/or conical. The upper and lower mold halves are brought together such that upper mold section 166 which is in the vicinity of where a kiss-off is to be formed faces lower mold section 168 which is also in the vicinity of the location where a kiss-off is to be formed. When the mold halves are brought together, gap 170 is formed. Weld 172 forms because the mold halves will be under some compression due to the weight of the upper mold half. Typically, gap 170 will be from about 0.5 to about 1.5 times the sum of the thickness of skin layer 158 and skin layer 160.

With reference to FIG. 9, a top view of the mounting of a mold half on a conveyor belt is provided. Mold half 180 is attached to conveyor 182 through pivot arms 184, 186 which allow mold half 180 to be rotated and tipped about the axis formed by pivot arms 184, 186. Mold half 180 can be lowered by positioning pivot arms 184, 186 over slots 188, 190. After such positioning, mold half 150 may then be lowered.

The method and apparatus of the present invention utilizes a powdered resin for forming the skin layers of a multilayer plastic part. The preferred skin layer resins include polyolefin-based resins, polystyrene-based resins, and polycarbonates. The preferred plastic resins are polyolefin-based resins such as high density polyethylene, low density polyethylene, linear low density polyethylene, polypropylene, polyisopropylene, polyisobutylene, polybutadiene, and the like. Further examples of polyolefin-based resins include homopolymers and copolymers synthesized from one or more of olefin monomers such as ethylene, propylene and butylene. The specific type of plastic resin used is determined by the end use requirements of such parameters as stiffness, creep, impact resistance, CLTE, and etc.

The skin resins used in the present invention includes an antioxidant preferably in an amount of about 450 ppm to about 1750 ppm. More preferably, the antioxidants are present in an amount of about 500 ppm to about 1000 ppm, and most preferably, the antioxidants are present in an amount of about 750 ppm. Suitable antioxidants include the phenol, phosphite, and thiol types of antioxidants. Preferably, the antioxidant is a blend of a phenolic antioxidant and a phosphite antioxidant. Examples of these antioxidants include Cyanox 2777 (a blend of a phenolic antioxidant and a phosphite antioxidant commercially available from Cytec Industries, West Paterson, N.J.) or a blend of Irganox 3114 (tris-(3,5-di-tert-butyl-4-hydroxybenzyl) isocyanurate commercially available from Ciba Speciality Chemicals) and a phosphite antioxidant such as Irgafos 168, Irgafos 12, or Ultranox 626. The antioxidant is important in improving stability and reducing yellowing. Furthermore, the antioxidants provide for the widest processing windows.

The skin resins optionally includes one or more additives. Suitable additives include, but are not limited to UV stabilizers, flame retardants, fillers, and pigments. Additives are important in establishing the long term stability of the skin resin as well as chemical and impact resistance. Specifically, the skin resin of the present invention optionally includes UV stabilizers present in an amount from about 1500 ppm to about 2500 ppm. More preferably the UV stabilizers are present in an amount of 1750 ppm to about 2250 ppm, and most preferably, the UV stabilizers are present in an amount of about 2000 ppm. Suitable UV stabilizers include, but are not limited to hindered amine light stabilizers (“HALS”). Examples of HALS include: Chimassorb 944, Chimassorb 994, Chimassorb 905, Tinuvin 770, Tinuvin 992, Tinuvin 622, Tinuvin 144, and Spinuvex A36 available from Geigy; and Cyasorb UV 3346 and Cyasorb UV 944 commercially available American Cyanamide. Particularly preferred UV stabilizers are Cytec UV 3346 and Chemasorb 944 (poly[N,N-bis(2,2,6,6-tetramethyl-4-piperidinyl)-1,6-hexanediamine-co-2,4-dichloro-6-morpholino-1,3,5-triazine.)

The skin resin still further optionally includes a flame retardant. Flame retardants include, for example, halogen-containing compounds, antimony oxides, or phosphorus compounds. Suitable flame retardants include, but are not limited to aluminum trihydrate, antimony oxide (Sb₂O₃), and decabromobiphenyl oxide (“decabrome”).

Finally, the skin resins may also include fillers such as long glass fibers, carbon fiber, and talc. These fillers allow the material properties of the skin resin to be adjusted. Preferably, these fillers are present in an amount of about 5% to 30% of the weight of the skin resin.

The skin resin is made by melt blending in which the plastic resin, the antioxidant, and optionally one or more other additives are mixed together and then extruded into pellets. Color pigments if desired are added in and melt blended to form pigmented pellets. The pellets are then ground and processed by methods known to those skilled in the art into a powder. Alternatively, the skin resin is made by mixing the plastic resin, the antioxidant, and optionally one or more other additives including color pigments and then processed by method known to those in the art into pellets. Accordingly, the skin resin is characterized by the average particle diameter of the powder into which the skin resin is processed. The average particle diameter is preferably from about 95 microns to about 1300 microns. More preferably the average particle diameter is from about 400 microns to about 600 microns, and most preferably about 500 microns. The skin resin of the present invention is further characterized by having a bulk density of about 15 to 60 g/100 cc, more preferably the bulk density is from 20 to 40 g/100 cc, and most preferably about 30 g/100 cc. The resin of the present invention is also characterized by its pourability. Pourability is evaluated by measuring the time in seconds that it takes for a 100 g sample of a powder to completely flow through an aluminum funnel (30° cone 0.380″ diameter opening). Preferably the skin resin powder of the present invention has a pourablity of about 5 to 50 seconds, more preferably the pourabilty is from about 10 to 40 seconds, and most preferably the pourability is about 28 seconds. The skin resin is still further characterized as having a melt index of 0.5 to 10 grams per 10 minutes, more preferably the melt index is 2 to 8 grams per minutes. The parameters for the particle size, pourability, and bulk density are important in providing the flow characteristics necessary to evenly distribute the skin layer and give a homogenous cross-section. The melt index is also important in determining flow properties and in particular determines the ability of the skin resin to cover corners.

The method and apparatus of the present invention also includes a foam resin capable of forming a foamed layer in a tip molding process. The preferred foam resin comprises a plastic resin and a blowing agent. Suitable plastic resins include polyolefin-based resins, polystyrene-based resins, and polycarbonates. The preferred plastic resins are polyolefin-based resins such as high density polyethylene, low density polyethylene, linear low density polyethylene, polypropylene, polyisopropylene, polyisobutylene, polybutadiene, and the like. Further examples of polyolefin-based resins include homopolymers and copolymers synthesized from one or more of olefin monomers such as ethylene, propylene and butylene. The specific type of plastic resin used is determined by the end use requirements of such parameters as stiffness, impact, CLTE, and etc.

The foam resin also includes a blowing agent in an amount of 1% to 12% of the total weight of the foam resin. Preferably, the blowing agent will have a particle size from about 0.5 to 30 microns. Blowing agents in this size range efficiently wet out on the surface of the plastic resin powder. A preferred blowing agent is azodicarbonimide. The activation temperature of the foam resin may be modified by the incorporation of additives in the blowing agent. For example, zinc oxide in an amount of about 0.1% to 0.75% of the weight of the blowing agent may be added to adjust the activation temperature. The foam resin is still further characterized as having a melt index of 0.5 to 10 grams per 10 minutes. For tip molding parts with a thin cross-section, the melt index is preferably from 5.0 to 20 grams per 10 minutes.

The foam resin is preferably made by grinding to the specifications below and then dry blending with the blowing agent. Accordingly, the foam resin is characterized by the particle diameter of the powder into which the foam resin is processed. The particle diameter is preferably from about 95 microns to about 1300 microns. The foam resin of the present invention is further characterized by having a bulk density of about 15-60 g/100 cc, more preferably the bulk density is from 20 to 40 g/100 cc, and most preferably about 30 g/100 cc. The resin of the present invention is also characterized by its pourability. Pourability is evaluated by measuring the time in seconds that it takes for a 100 g sample of a powder to completely flow through an aluminum funnel (30° cone 0.380″ diameter opening). Preferably the skin resin powder of the present invention has a pourablity of about 5 to 50 seconds, more preferably the pourabilty is from about 10 to 40 seconds, and most preferably the pourability is about 28 seconds. The skin resin is still further characterized as having a melt index of 0.5 to 10 grams per 10 minutes. For applications in which part with thin cross-sections, the melt index is preferably from 5.0 to 20 g/10 min. The parameters for the particle size, pourability, melt index, and bulk density are important in providing the flow characteristics necessary to evenly distribute the foam layer, adhere to reinforcements, and give a homogenous cross-section particularly for thin cross-sections.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tip molding apparatus for forming a three layered plastic part, the tip molding apparatus comprising:
a conveyor for transporting a mold half through the tip molding apparatus;
an oven for heating the mold half, wherein the conveyor transports the mold half through the oven;
a skin resin loader that introduces a first powder resin into the mold half after the mold half exits the oven; and
at least one mold inverter that inverts the male mold half by a sufficient amount to pour out any first powder resin not adhered to the first mold half.

2. The tip molding apparatus of claim 1 further comprising a station located after the oven and before the skin resin loader for a placing the mold half in an isolation box.

3. The tip molding apparatus of claim 1 wherein the skin resin loader comprises a hopper and a robot, wherein the robot moves the hopper along the mold half while the skin resin powder is introduced into the mold half.

4. The tip molding apparatus of claim 2 further comprising a station for placing reinforcements into the mold halve.

5. The tip molding apparatus of claim 4 wherein the station for placing reinforcements into the mold halve comprises a robot and a reinforcement transporting conveyor, wherein the reinforcement transporting conveyor transfers reinforcements to the robot and the robot places the reinforcements into the mold half.

6. The tip molding apparatus of claim 1 further comprising a foam resin loader that introduces a foam resin into the mold half.

7. The tip molding apparatus of claim 1 wherein the foam resin loader comprises a hopper and a robot, wherein the robot moves the hopper along the mold half while the skin resin powder is introduced into the mold half.

8. The tip molding apparatus of claim 1 further comprising a mold joiner that joins two mold valves together.

9. The tip molding apparatus of claim 1 further comprising a blowing oven for activating the foam resin placed in the mold half.

10. The tip molding apparatus of claim 1 further comprising a cooling station.

11. The tip molding apparatus of claim 1 further comprising a mold separator that separates the two mold halves and removes the three layered plastic part.

12. A method of forming a three layered plastic part a tip molding process, the method comprising:
transporting a first mold half through an oven wherein the first mold half is heated by the oven;
introducing a powdered skin resin into the mold half after the mold half exits the oven wherein a plastic skin layer covering at least a portion of first mold half forms; and
inverting the male mold half by a sufficient amount to pour out any powdered skin resin not adhered to the first mold half.

13. The method of claim 12 further comprising placing the first mold half in an isolation box.

14. The method of claim 12 further comprising placing reinforcements into the first mold half.

15. The method of claim 14 further comprising introducing a foam resin into the first mold half.

16. The method of claim 15 further comprising a joining the first mold half with a second mold half to form joined mold halves, wherein a portion of the second mold half is coated with a plastic skin layer.

17. The method of claim 16 further comprising activating the foam resin.

18. The method of claim 17 wherein the foam resin is activated by transporting the joined mold halves through an oven.

19. The method of claim 18 further comprising cooling the joined mold halves.

20. The method of clam 19 further comprising separating the joined mold halves and removing the three layered plastic part.
